(19) United States
(12) Patent Application Publication
(10) Pub. No.: US 2003/0136942 A1
(43) Pub. Date: Jul. 24, 2003

(54) Stabilized active oxygen compositions

(76) Inventors: Kim R. Smith, Woodbury, MN (US); Mark Levitt, St. Paul, MN (US); Keith E. Olson, Apple Valley, MN (US)

Correspondence Address: MERCHANT & GOULD PC, P.O. BOX 2903, MINNEAPOLIS, MN, 55402-0903, US

(21) Appl. No.: 10/299,519

(22) Filed: Nov. 18, 2002

Related U.S. Application Data
(60) Provisional application No. 60/335,279, filed on Nov. 30, 2001.

(51) Int. Cl. A01N 1/00; C09K 3/00

(52) U.S. Cl. 252/186.26; 252/186.27

(57) ABSTRACT

The present invention relates to compositions including a combination of builders that stabilizes active oxygen compounds when the composition is formulated as an alkaline liquid.

### FIELD OF THE INVENTION

The present invention relates to compositions including a combination of builders that stabilizes active oxygen compounds when the composition is formulated or dispensed as an alkaline liquid.

### BACKGROUND OF THE INVENTION

Many cleaning and sanitizing compositions include active oxygen compounds including peroxy moieties. The useful life of such cleaning and sanitizing compositions can be limited by the decomposition of the peroxy moiety, particularly under alkaline aqueous conditions. There remains a need for cleaning and sanitizing compositions with longer lasting peroxy moieties.

### SUMMARY OF THE INVENTION

The present invention relates to compositions including a combination of builders that stabilizes active oxygen compounds when the composition is formulated or dispensed as an alkaline liquid. Suitable combinations of builders include two or more of phosphonate builders, phosphate builders, aminocarboxylate builders, polycarboxylate builders, inorganic builders, or organic builders; including salt or acid forms of these builders. Preferred builders include aminocarboxylates such as ethylenediaminetetraacetic acid (EDTA), diethylenetriaminepentaacetic acid (DTPA), hydroxyethylenediaminetetraacetic acid (HEDTA), nitrilotriacetic acid (NTA), and iminodisuccinic acid (IDS); phosphonates such as aminotri(methylene phosphonic acid) (ATMP), hydroxyethylidene-1,1-diphosphonic acid (HEDP), hexamethylenediamine penta(methylenephosphonic acid); phosphates such as sodium tripolyphosphate (STPP), sodium pyrophosphate, sodium phosphate, and sodium hexametaphosphate; polycarboxylates such as citric acid, gluconic acid, oxalic acid, sodium polyacrylate, and salts of these acids; inorganic builders such as zeolite; and organic builders such as salicylic acid and 5-sulfosalicylic acid; including salt or acid forms of these builders.

The present builder combinations cause advantageous increases in the stability of peroxygen compounds in liquid compositions. The builder combination is selected to be and is employed at a concentration that is effective to stabilize an active oxygen compound, such as a peroxide, in a liquid composition. In an embodiment, the mixture of builders is effective to stabilize active oxygen compound to the extent that at least about 50% of the active oxygen compound remains in a liquid composition after 24 hours at 120° F. In an embodiment, at least about 70% of the active oxygen compound remains in a liquid composition after 24 hours at 120° F.

Typically, for cleaning and sanitizing compositions, other optional ingredients can be incorporated into the compositions, including, for example, surfactant, salt or additional salt, water, alkalinity source, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, other such additives or functional ingredients, and the like, and mixtures thereof.

### BRIEF DESCRIPTION OF THE FIGURES

FIG. 1 illustrates the stability of active oxygen compound in liquid compositions including aminocarboxylate and polycarboxylic acid builder.

### DETAILED DESCRIPTION OF THE INVENTION

Definitions

An “active oxygen compound” is an agent containing or acting as a source of active oxygen. Preferred active oxygen compounds release active oxygen in aqueous solutions.

A “peroxygen compound” or “peroxide” means a compound containing a peroxy moiety, —O—O—, or adducts of such compounds, in which at least one of the oxygen atoms is active.

An “active oxygen compound adduct” is a physical adduct containing active oxygen compound associated with a second molecule.

A “peroxygen compound adduct” is a physical adduct containing peroxygen compound associated with a second molecule.

A “hydrogen peroxide adduct” or a “peroxyhydrate” is an adduct containing molecular hydrogen peroxide. On dissolution in water, hydrogen peroxide adducts (peroxyhydrates) liberate hydrogen peroxide into solution.

“Inorganic active oxygen compound(s)” are active oxygen compounds wherein the active oxygen is attached to an inorganic group, or it can bridge two inorganic groups.

“Inorganic peroxide” compounds are peroxygen compound wherein the peroxide group is attached to an inorganic group through one or two of the oxygen atoms, or it can bridge two inorganic groups.

“Organic active oxygen compound(s)” are active oxygen compounds wherein the active oxygen is attached to a group containing carbon, or it can bridge two groups containing carbon.

“Organic peroxide” compounds are peroxygen compounds wherein the peroxide group is attached to a group containing carbon or phosphorus through one or two of the oxygen atoms, or it can bridge two groups containing carbon.

“Phosphonate” means a class of organophosphonic acids including one of the general formula:

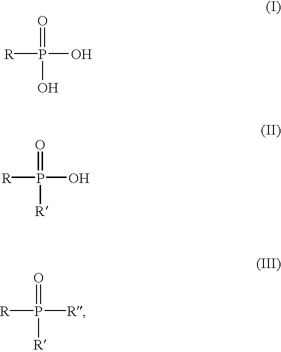

and acceptable salts and esters thereof, wherein R, R′ and R′″ are each organic groups. The phosphonate of formula I is typically preferred.

An “aminocarboxylic acid” is an acid having at least one amino group and at least one carboxylic acid substituent.

An “alkali metal carbonate” is a compound including at least one alkali metal and at least one carbonate group.

The term “functional material” or “functional additives” refers to an active compound or material that affords desirable properties to the solid, agglomerate, dissolved, or suspended composition. For example, the functional material can afford desirable properties to the solid or agglomerate composition such as enhancing solidification characteristics or dilution rate. The functional material can also, when dissolved or dispersed in an aqueous phase, provide a beneficial property to the aqueous material when used. Examples of functional materials include surfactant, softening agent, buffer, anti-corrosion agent, bleach activator, hardening agent, solubility modifier, detergent filler, defoamer, anti-redeposition agent, antimicrobial, a precipitation threshold agent or system, aesthetic enhancing agent (i.e., dye, perfume), bleaching agent, functional salt, hardening agent, enzyme, other such additive or functional ingredient, and the like, and mixtures thereof. Functional materials added to a composition will vary according to the type of composition being manufactured, and the intended end use of the composition.

“Cleaning” means to perform or aid in soil removal, bleaching, or combination thereof.

As used herein, a solid stabilized composition refers to a stabilized composition in the form of a solid such as a powder, a flake, a granule, a pellet, a tablet, a lozenge, a puck, a briquette, a brick, a solid block, a unit dose, or another known solid form.

As used herein, the term “agglomerate” refers to a stabilized composition including particles gathered together to form a larger particle having varying degrees of open spaces or voids between its individual component particles.

As used herein, the term “microorganism” refers to any noncellular or unicellular (including colonial) organism. Microorganisms include all prokaryotes. Microorganisms include bacteria (including cyanobacteria and Mycobacteria), lichens, fungi, mold, protozoa, virinos, viroids, viruses, and some algae. As used herein, the term “microbe” is synonymous with microorganism.

As used herein, weight percent (wt- %), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Differentiation of antimicrobial “-cidal” or “-static” activity, the definitions which describe the degree of efficacy, and the official laboratory protocols for measuring this efficacy are considerations for understanding the relevance of antimicrobial agents and compositions. Antimicrobial compositions can effect two kinds of microbial cell damage. The first is a lethal, irreversible action resulting in complete microbial cell destruction or incapacitation. The second type of cell damage is reversible, such that if the organism is rendered free of the agent, it can again multiply. The former is termed bacteriocidal and the later, bacteriostatic. A sanitizer and a disinfectant are, by definition, agents which provide antibacterial or bacteriocidal activity. In contrast, a preservative is generally described as an inhibitor or bacteriostatic composition.

For the purpose of this patent application, successful reduction of microorganisms is achieved when the populations of microorganisms are reduced by at least about 0.3-1 log₁₀. In this application, such a population reduction is the minimum acceptable for the processes.

Any increased reduction in population of microorganisms is an added benefit that provides higher levels of protection. For example, a carpet sanitizer results in a 99.9% reduction (3 log order reduction ) in one or more microorganisms in a carpet sample in a test procedure defined by the EPA at US EPA—Efficacy Data Requirements: Carpet Sanitizers DIS/TSS-8 April 18, 1981, the contents of which are incorporated herein by reference.

The Stabilized Active Oxygen Composition

The present invention relates to compositions including a combination of builders that stabilizes active oxygen compounds when the composition is formulated or dispensed as an alkaline liquid. The present compositions can be formulated as solids, agglomerates, liquids, gels, or other physical forms. Typically the present compositions are formulated as alkaline liquid concentrate of use compositions either before or for use. The builder combination provides advantageous stability for the active oxygen compound in such an alkaline liquid composition. Preferably, the combination of builders gives rise to more than additive or synergistic increase stability of the active oxygen compound compared to either builder alone.

The present stabilized active oxygen composition includes an active oxygen compound and a combination of builders. The active oxygen compound can provide cleaning, bleaching, antimicrobial activity, and other desirable properties for such a composition. The combination of builders provides greater stability for the active oxygen compound, when the composition is formulated as an alkaline liquid, compared to a liquid composition lacking the combination of builders. Preferably, the combination of builders exhibits a greater than additive or a synergistic increase in stability of the active oxygen compound compared to a liquid composition including only one builder from the combination.

Suitable combinations of builders can include two or more phosphonates, two or more phosphates, two or more aminocarboxylates, two or more polycarboxylates, or two or more inorganic builders, or two or more organic builders. Suitable combinations of builders can include phosphonate plus phosphate, aminocarboxylate, polycarboxylate, inorganic builder, or organic builder. Suitable combinations of builders can include phosphate plus aminocarboxylate, polycarboxylate, inorganic builder, or organic builder. Suitable combinations of builders can include aminocarboxylate plus polycarboxylate, inorganic builder, or organic builder. Suitable combinations of builders can include polycarboxylate plus inorganic builder or organic builder. Suitable combinations of builders can include phosphonate plus phosphate, phosphonate plus aminocarboxylate, phosphonate plus polycarboxylate, phosphonate plus inorganic builder, or phosphonate plus organic builder. Suitable combinations of builders can include phosphate plus aminocarboxylate, phosphate plus polycarboxylate, phosphate plus inorganic builder, or phosphate plus organic builder. Suitable combinations of builders can include aminocarboxylate plus polycarboxylate, aminocarboxylate plus inorganic builder, or aminocarboxylate plus organic builder. Suitable combinations of builders can include polycarboxylate plus inorganic builder or polycarboxylate plus organic builder. Suitable combinations of builders can include inorganic builder plus organic builder. These builders can be either acid or salt forms, or mixtures thereof. Preferred combinations include two or three builders, preferably two builders.

Suitable combinations of builders can include EDTA plus one or more of DTPA, HEDTA, NTA, IDS, ATMP, HEDP, hexamethylenediamine penta(methylene phosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include DTPA plus one or more of HEDTA, NTA, IDS, ATMP, HEDP, hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include HEDTA plus one or more of NTA, IDS, ATMP, HEDP, hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include NTA plus one or more of IDS, ATMP, HEDP, hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include IDS plus one or more of ATMP, HEDP, hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include ATMP plus one or more of HEDP, hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include HEDP plus one or more of hexamethylenediamine penta(methylenephosphonic acid), STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include hexamethylenediamine penta(methylenephosphonic acid) plus one or more of STPP, sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include STPP plus one or more of sodium pyrophosphate, sodium phosphate, sodium hexametaphosphate, citric acid, gluconic acid, oxalic acid, sodium polyacrylate, zeolite, salicylic acid, or 5-sulfosalicylic acid. Suitable combinations of builders can include sodium pyrophosphate plus one or more of sodium phosphate, sodium hexametaphosphate, citric acid, gluconic acid, oxalic acid, sodium polyacrylate, zeolite, salicylic acid, or 5-sulfosalicylic acid. Suitable combinations of builders can include sodium phosphate plus one or more of sodium hexametaphosphate, citric acid, gluconic acid, oxalic acid, sodium polyacrylate, zeolite, salicylic acid, or 5-sulfosalicylic acid. Suitable combinations of builders can include sodium hexametaphosphate plus one or more of citric acid, gluconic acid, oxalic acid, sodium polyacrylate, zeolite, salicylic acid, or 5-sulfosalicylic acid. Suitable combinations of builders can include citric acid plus one or more of gluconic acid, oxalic acid, sodium polyacrylate, zeolite, salicylic acid, or 5-sulfosalicylic acid. Suitable combinations of builders can include gluconic acid plus one or more of oxalic acid, sodium polyacrylate, zeolite, salicylic acid, or 5-sulfosalicylic acid. Suitable combinations of builders can include oxalic acid plus one or more of sodium polyacrylate, zeolite, salicylic acid, or 5-sulfosalicylic acid. Suitable combinations of builders can include sodium polyacrylate plus one or more of zeolite, salicylic acid, or 5-sulfosalicylic acid. Suitable combinations of builders can include zeolite plus one or more of salicylic acid or 5-sulfosalicylic acid. Suitable combinations of builders can include salicylic acid plus 5-sulfosalicylic acid. These builders can be either acid or salt forms, or mixtures thereof. Preferred combinations include two or three builders, preferably two builders.

Suitable combinations of builders can include EDTA plus DTPA, EDTA plus HEDTA, EDTA plus NTA, EDTA plus IDS, EDTA plus ATMP, EDTA plus HEDP, EDTA plus hexamethylenediamine penta(methylenephosphonic acid), EDTA plus STPP, EDTA plus sodium pyrophosphate, EDTA plus sodium phosphate, EDTA plus sodium hexametaphosphate, EDTA plus citric acid, EDTA plus gluconic acid, EDTA plus oxalic acid, EDTA plus sodium polyacrylate, EDTA plus zeolite, EDTA plus salicylic acid, or EDTA plus 5-sulfosalicylic acid. Suitable combinations of builders can include DTPA plus HEDTA, DTPA plus NTA, DTPA plus IDS, DTPA plus ATMP, DTPA plus HEDP, DTPA plus hexamethylenediamine penta(methylenephosphonic acid), DTPA plus STPP, DTPA plus sodium pyrophosphate, DTPA plus sodium phosphate, DTPA plus sodium hexametaphosphate, DTPA plus citric acid, DTPA plus gluconic acid, DTPA plus oxalic acid, DTPA plus sodium polyacrylate, DTPA plus zeolite, DTPA plus salicylic acid, or DTPA plus 5-sulfosalicylic acid. Suitable combinations of builders can include HEDTA plus NTA, HEDTA plus IDS, HEDTA plus ATMP, HEDTA plus HEDP, HEDTA plus hexamethylenediamine penta(methylenephosphonic acid), HEDTA plus STPP, HEDTA plus sodium pyrophosphate, HEDTA plus sodium phosphate, HEDTA plus sodium hexametaphosphate, HEDTA plus citric acid, HEDTA plus gluconic acid, HEDTA plus oxalic acid, HEDTA plus sodium polyacrylate, HEDTA plus zeolite, HEDTA plus salicylic acid, or HEDTA plus 5-sulfosalicylic acid. Suitable combinations of builders can include NTA plus IDS, NTA plus ATMP, NTA plus HEDP, NTA plus hexamethylenediamine penta(methylenephosphonic acid), NTA plus STPP, NTA plus sodium pyrophosphate, NTA plus sodium phosphate, NTA plus sodium hexametaphosphate, NTA plus citric acid, NTA plus gluconic acid, NTA plus oxalic acid, NTA plus sodium polyacrylate, NTA plus zeolite, NTA plus salicylic acid, or NTA plus 5-sulfosalicylic acid. Suitable combinations of builders can include IDS plus ATMP, IDS plus HEDP, IDS plus hexamethylenediamine penta(methylenephosphonic acid), IDS plus STPP, IDS plus sodium pyrophosphate, IDS plus sodium phosphate, IDS plus sodium hexametaphosphate, IDS plus citric acid, IDS plus gluconic acid, IDS plus oxalic acid, IDS plus sodium polyacrylate, IDS plus zeolite, IDS plus salicylic acid, or IDS plus 5-sulfosalicylic acid. Suitable combinations of builders can include ATMP plus HEDP, ATMP plus hexamethylenediamine penta(methylenephosphonic acid), ATMP plus STPP, ATMP plus sodium pyrophosphate, ATMP plus sodium phosphate, ATMP plus sodium hexametaphosphate, ATMP plus citric acid, ATMP plus gluconic acid, ATMP plus oxalic acid, ATMP plus sodium polyacrylate, ATMP plus zeolite, ATMP plus salicylic acid, or ATMP plus 5-sulfosalicylic acid. Suitable combinations of builders can include HEDP plus hexamethylenediamine penta(methylenephosphonic acid), HEDP plus STPP, HEDP plus sodium pyrophosphate, HEDP plus sodium phosphate, HEDP plus sodium hexametaphosphate, HEDP plus citric acid, HEDP plus gluconic acid, HEDP plus oxalic acid, HEDP plus sodium polyacrylate, HEDP plus zeolite, HEDP plus salicylic acid, or HEDP plus 5-sulfosalicylic acid. Suitable combinations of builders can include hexamethylenediamine penta(methylenephosphonic acid) plus STPP, hexamethylenediamine penta(methylenephosphonic acid) plus sodium pyrophosphate, hexamethylenediamine penta(methylenephosphonic acid) plus sodium phosphate, hexamethylenediamine penta(methylenephosphonic acid) plus sodium hexametaphosphate, hexamethylenediamine penta(methylenephosphonic acid) plus citric acid, hexamethylenediamine penta(methylenephosphonic acid) plus gluconic acid, hexamethylenediamine penta(methylenephosphonic acid) plus oxalic acid, hexamethylenediamine penta(methylenephosphonic acid) plus sodium polyacrylate, hexamethylenediamine penta(methylenephosphonic acid) plus zeolite, hexamethylenediamine penta(methylenephosphonic acid) plus salicylic acid, or hexamethylenediamine penta(methylenephosphonic acid) plus 5-sulfosalicylic acid. Suitable combinations of builders can include STPP plus sodium pyrophosphate, STPP plus sodium phosphate, STPP plus sodium hexametaphosphate, STPP plus citric acid, STPP plus gluconic acid, STPP plus oxalic acid, STPP plus sodium polyacrylate, STPP plus zeolite, STPP plus salicylic acid, or STPP plus 5-sulfosalicylic acid. Suitable combinations of builders can include sodium pyrophosphate plus sodium phosphate, sodium pyrophosphate plus sodium hexametaphosphate, sodium pyrophosphate plus citric acid, sodium pyrophosphate plus gluconic acid, sodium pyrophosphate plus oxalic acid, sodium pyrophosphate plus sodium polyacrylate, sodium pyrophosphate plus zeolite, sodium pyrophosphate plus salicylic acid, or sodium pyrophosphate plus 5-sulfosalicylic acid. Suitable combinations of builders can include sodium phosphate plus sodium hexametaphosphate, sodium phosphate plus citric acid, sodium phosphate plus gluconic acid, sodium phosphate plus oxalic acid, sodium phosphate plus sodium polyacrylate, sodium phosphate plus zeolite, sodium phosphate plus salicylic acid, or sodium phosphate plus 5-sulfosalicylic acid. Suitable combinations of builders can include sodium hexametaphosphate plus citric acid, sodium hexametaphosphate plus gluconic acid, sodium hexametaphosphate plus oxalic acid, sodium hexametaphosphate plus sodium polyacrylate, sodium hexametaphosphate plus zeolite, sodium hexametaphosphate plus salicylic acid, or sodium hexametaphosphate plus 5-sulfosalicylic acid. Suitable combinations of builders can include citric acid plus gluconic acid, citric acid plus oxalic acid, citric acid plus sodium polyacrylate, citric acid plus zeolite, citric acid plus salicylic acid, or citric acid plus 5-sulfosalicylic acid. Suitable combinations of builders can include gluconic acid plus oxalic acid, gluconic acid plus sodium polyacrylate, gluconic acid plus zeolite, gluconic acid plus salicylic acid, or gluconic acid plus 5-sulfosalicylic acid. Suitable combinations of builders can include oxalic acid plus sodium polyacrylate, oxalic acid plus zeolite, oxalic acid plus salicylic acid, or oxalic acid plus 5-sulfosalicylic acid. Suitable combinations of builders can include sodium polyacrylate plus zeolite, sodium polyacrylate plus salicylic acid, or sodium polyacrylate plus 5-sulfosalicylic acid. Suitable combinations of builders can include zeolite plus salicylic acid or zeolite plus 5-sulfosalicylic acid. Suitable combinations of builders can include salicylic acid plus 5-sulfosalicylic acid. These builders can be either acid or salt forms, or mixtures thereof. Preferred combinations include two or three builders, preferably two builders.

Preferred combinations of builders can include aminocarboxylate builder plus one or more of phosphonate builder or polycarboxylate builder. Preferred combinations of builders can include aminocarboxylate builder plus phosphonate builder or aminocarboxylate builder plus polycarboxylate builder. Preferred combinations of builders can include polycarboxylate builder plus phosphonate builder. These builders can be either acid or salt forms, or mixtures thereof. Preferred combinations include two or three builders, preferably two builders.

Preferred combinations of builders can include EDTA plus one or more of citric acid, ATMP, HEDP, or hexamethylenediamine penta(methylene phosphonic acid). Preferred combinations of builders can include citric acid plus one or more of ATMP, HEDP, or hexamethylenediamine penta(methylene phosphonic acid). Preferred combinations of builders can include EDTA plus citric acid, EDTA plus ATMP, EDTA plus HEDP, or EDTA plus hexamethylenediamine penta(methylene phosphonic acid). Preferred combinations of builders can include citric acid plus ATMP, citric acid plus HEDP, or citric acid plus hexamethylenediamine penta(methylene phosphonic acid). These builders can be either acid or salt forms, or mixtures thereof Preferred combinations include two or three builders, preferably two builders.

The builder combination is selected to be and is employed at a concentration that is effective to stabilize an active oxygen compound, such as a peroxide, in a liquid composition. In an embodiment, the mixture of builders is effective to stabilize active oxygen compound to the extent that at least about 50% of the active oxygen compound remains in a liquid composition after 24 hours at 120° F. In an embodiment, at least about 70% of the active oxygen compound remains in a liquid composition after 24 hours at 120° F.

Some examples of solid compositions according to or employed in the methods of the present invention can be found in Tables 1 and 2, in which the values are given in wt- % of the ingredients in reference to the total composition weight.

TABLE 1
Compositions Including Combinations of Builders that
Stabilize Active Oxygen Compounds.

| | Preferred | Preferred | Preferred | Preferred |
|---|---|---|---|---|
| Component | wt-% Range | wt-% Range | wt-% Range | wt-% Range |
| Active | 30-80 | 40-70 | 50-60 | 55 |
| Oxygen | | | | |
| Compound | | | | |
| Builder | 5-60 | 10-40 | 20-25 | 22 |
| Combination | (5-95: | (40-90: | (40-70: | (60:40) |
| (ratio of | 95-5) | 60-10) | 60-30) | |
| builders | | | | |
| in the | | | | |
| combination) | | | | |

TABLE 2
Additional Compositions Including Combinations of Builders
that Stabilize Active Oxygen Compounds.

| | Preferred | Preferred | Preferred | Preferred |
|---|---|---|---|---|
| Component | wt-% Range | wt-% Range | wt-% Range | wt-% Range |
| Active | 5-60 | 25-60 | 50-60 | 55 |
| Oxygen | | | | |
| Compound | | | | |
| Builder | 10-50 | 15-40 | 20-25 | 22 |
| Combination | (5-95: | (40-90: | (40-70: | (60:40) |
| (ratio of | 95-5) | 60-10) | 60-30) | |
| builders | | | | |
| in the | | | | |
| combination) | | | | |

Certain preferred compositions include the ranges of ingredients listed in Table 3.

TABLE 3
Compositions Including Combinations of Builders that Stabilize
Active Oxygen Compounds.

| | Preferred | Preferred | Preferred | Preferred |
|---|---|---|---|---|
| Component | wt-% Range | wt-% Range | wt-% Range | wt-% Range |
| Active | 30-80 | 40-70 | 50-60 | 55 |
| Oxygen | | | | |
| Compound | | | | |
| Surfactant | 1-15 | 5-15 | 5-10 | 7 |
| Builder | 5-60 | 10-40 | 20-25 | 22 |
| (ratio | (5-95: | (40-90: | (40-70: | (60:40) |
| polycar- | 95-5) | 60-10) | 60-30) | |
| boxylic | | | | |
| acid: | | | | |
| aminocar- | | | | |
| boxylate) | | | | |

Additional preferred compositions include the ranges of ingredients listed in Table 4.

TABLE 4
Additional Compositions Including Combinations of Builders
that Stabilize Active Oxygen Compounds.

| | Preferred | Preferred | Preferred | Preferred |
|---|---|---|---|---|
| Component | wt-% Range | wt-% Range | wt-% Range | wt-% Range |
| Active Oxygen | 5-60 | 25-60 | 50-60 | 55 |
| Compound | | | | |
| Alkalinity | 10-50 | 10-35 | 15-20 | 18 |
| Source | | | | |
| Surfactant | 1-15 | 5-15 | 5-10 | 7 |
| Builder | 10-50 | 15-40 | 20-25 | 22 |
| (ratio | (5-95: | (40-90: | (40-70: | (60:40) |
| polycar- | 95-5) | 60-10) | 60-30) | |
| boxylic | | | | |
| acid: | | | | |
| aminocar- | | | | |
| boxylate) | | | | |

The compositions described in Tables 2 and 3 stabilize active oxygen compound in a liquid composition, such as a liquid use or concentrate composition. Compositions including a combination of builders have been determined to stabilize active oxygen compounds in liquid compositions. Stabilizing active oxygen compound includes providing higher concentrations of active oxygen compound for longer times compared to control compositions. Active oxygen compound concentrations can be measured as total peroxide in a liquid composition. Preferred compositions for stabilizing active oxygen compound include polycarboxylic acid (e.g., citric acid) and aminocarboxylate (e.g., EDTA) as builder.

Preferably, the stabilized composition includes about 30 to about 80 wt- % active oxygen compound and about 5 to about 60 wt- % builder combination. Preferably, the stabilized composition includes about 40 to about 70 wt- % active oxygen compound and about 10 to about 40 wt- % builder combination. Preferably, the stabilized composition includes about 50 to about 60 wt- % active oxygen compound and about 20 to about 25 wt- % builder combination. Preferably, the stabilized composition includes about 5 to about 60 wt- % active oxygen compound and about 10 to about 50 wt- % builder. Preferably, the stabilized composition includes about 25 to about 60 wt- % active oxygen compound and about 15 to about 40 wt- % builder. Preferably, the stabilized composition includes about 50 to about 60 wt- % active oxygen compound and about 20 to about 25 wt- % builder. Preferably, the stabilized composition includes about 55 wt- % active oxygen compound and about 22 wt- % builder. Preferably the builder combination in such a composition includes about 5 to about 95 wt- % of one builder and about 5 to about 95 wt- % of another; preferably about 40 to about 90 wt- % and about 10 to about 40 wt- %; preferably about 40 to about 70 wt- % and about 30 to about 60 wt- %; preferably about 60 wt- % and about 40 wt- %.

Preferably, the stabilized composition includes about 30 to about 80 wt- % active oxygen compound; about 1 to about 15 wt- % surfactant; and about 5 to about 60 wt- % builder. Preferably, the stabilized composition includes about 40 to about 70 wt- % active oxygen compound; about 5 to about 15 wt- % surfactant; and about 10 to about 40 wt- % builder. Preferably, the stabilized composition includes about 50 to about 60 wt- % active oxygen compound; about 5 to about 10 wt- % surfactant; and about 20 to about 25 wt- % builder. Preferably, the stabilized composition includes about 55 wt- % active oxygen compound; about 7 wt- % surfactant; and about 22 wt- % builder. Preferably the builder in such a composition includes about 5 to about 95 wt- % polycarboxylic acid (e.g., citric acid) and about 5 to about 95 wt- % aminocarboxylate (e.g., EDTA); preferably about 40 to about 90 wt- % polycarboxylic acid (e.g., citric acid) and about 10 to about 40 wt- % aminocarboxylate (e.g., EDTA); preferably about 40 to about 70 wt- % polycarboxylic acid (e.g., citric acid) and about 30 to about 60 wt- % aminocarboxylate (e.g., EDTA); preferably about 60 wt- % polycarboxylic acid (e.g., citric acid) and about 40 wt- % aminocarboxylate (e.g., EDTA). Preferably the active oxygen compound includes a peroxide adduct (e.g. percarbonate) and the surfactant includes a nonionic surfactant (e.g., an alcohol ethoxylate).

Preferably, the stabilized composition includes about 5 to about 60 wt- % active oxygen compound; about 10 to about 50 wt- % alkalinity source; about 1 to about 15 wt- % surfactant; and about 10 to about 50 wt- % builder. Preferably, the stabilized composition includes about 25 to about 60 wt- % active oxygen compound; about 10 to about 35 wt- % alkalinity source; about 5 to about 15 wt- % surfactant; and about 15 to about 40 wt- % builder. Preferably, the stabilized composition includes about 50 to about 60 wt- % active oxygen compound; about 15 to about 20 wt- % alkalinity source; about 5 to about 10 wt- % surfactant; and about 20 to about 25 wt- % builder. Preferably, the stabilized composition includes about 55 wt- % active oxygen compound; about 18 wt- % alkalinity source; about 7 wt- % surfactant; and about 22 wt- % builder. Preferably the builder in such a composition includes about 5 to about 95 wt- % polycarboxylic acid (e.g., citric acid) and about 5 to about 95 wt- % aminocarboxylate (e.g., EDTA); preferably about 40 to about 90 wt- % polycarboxylic acid (e.g., citric acid) and about 10 to about 40 wt- % aminocarboxylate (e.g., EDTA); preferably about 40 to about 70 wt- % polycarboxylic acid (e.g., citric acid) and about 30 to about 60 wt- % aminocarboxylate (e.g., EDTA); preferably about 60 wt- % polycarboxylic acid (e.g., citric acid) and about 40 wt- % aminocarboxylate (e.g., EDTA). Preferably the active oxygen compound includes a peroxide adduct (e.g. percarbonate), the alkalinity source includes a carbonate source (e.g. sodium carbonate), and the surfactant includes a nonionic surfactant (e.g., an alcohol ethoxylate).

Active Oxygen Compound

The active oxygen compound acts to provide a source of active oxygen and stain bleaching, and also, preferably, provides antimicrobial action. The active oxygen compound can be inorganic or organic, and can be a mixture thereof. Some examples of active oxygen compound include peroxygen compounds, and peroxygen compound adducts.

Many active oxygen compounds are peroxygen compounds. Any peroxygen compound generally known, and that preferably can provide antimicrobial action, can be used. Examples of suitable peroxygen compounds include inorganic and organic peroxygen compounds, or mixtures thereof.

Inorganic Active Oxygen Compounds

Examples of inorganic active oxygen compounds include the following types of compounds or sources of these compounds, or alkali metal salts including these types of compounds, or forming an adduct therewith:

hydrogen peroxide;

group 1 (IA) active oxygen compounds, for example lithium peroxide, sodium peroxide, and the like;

group 2 (IIA) active oxygen compounds, for example magnesium peroxide, calcium peroxide, strontium peroxide, barium peroxide, and the like;

group 12 (IIB) active oxygen compounds, for example zinc peroxide, and the like;

group 13 (IIIA) active oxygen compounds, for example boron compounds, such as perborates, for example sodium perborate hexahydrate of the formula Na₂[Br₂(O₂)₂(OH)₄].6H₂O (also called sodium perborate tetrahydrate and formerly written as NaBO₃.4H₂O); sodium peroxyborate tetrahydrate of the formula Na₂Br₂(O₂)₂[(OH)₄].4H₂O (also called sodium perborate trihydrate, and formerly written as NaBO₃.3H₂O); sodium peroxyborate of the formula Na₂[B₂(O₂)₂(OH)₄] (also called sodium perborate monohydrate and formerly written as NaBO₃.H₂O); and the like; preferably perborate;

group 14 (IVA) active oxygen compounds, for example persilicates and peroxycarbonates, which are also called percarbonates, such as persilicates or peroxycarbonates of alkali metals; and the like; preferably percarbonate;

group 15 (VA) active oxygen compounds, for example peroxynitrous acid and its salts; peroxyphosphoric acids and their salts, for example, perphosphates; and the like; preferably perphosphate;

group 16 (VIA) active oxygen compounds, for example peroxysulfuric acids and their salts, such as peroxymonosulfuric and peroxydisulfuric acids, and their salts, such as persulfates, for example, sodium persulfate; and the like; preferably persulfate;

group VIIa active oxygen compounds such as sodium periodate, potassium perchlorate and the like.

Other active inorganic oxygen compounds can include transition metal peroxides; and other such peroxygen compounds, and mixtures thereof.

Preferably, the compositions and methods of the present invention employ certain of the inorganic active oxygen compounds listed above. Preferred inorganic active oxygen compounds include hydrogen peroxide, hydrogen peroxide adduct, group IIIA active oxygen compound group, VIA active oxygen compound, group VA active oxygen compound, group VIIA active oxygen compound, or mixtures thereof. Preferred examples of such inorganic active oxygen compounds include percarbonate, perborate, persulfate, perphosphate, persilicate, or mixtures thereof. Hydrogen peroxide presents one preferred example of an inorganic active oxygen compound. Hydrogen peroxide can be formulated as a mixture of hydrogen peroxide and water, e.g., as liquid hydrogen peroxide in an aqueous solution. The mixture of solution can include about 5 to about 40 wt- % hydrogen peroxide, preferably 5 to 50 wt- % hydrogen peroxide.

In an embodiment, the preferred inorganic active oxygen compounds include hydrogen peroxide adduct. For example, the inorganic active oxygen compounds can include hydrogen peroxide, hydrogen peroxide adduct, or mixtures thereof. Any of a variety of hydrogen peroxide adducts are suitable for use in the present compositions and methods. For example, suitable hydrogen peroxide adducts include alkali metal percarbonate salt, urea peroxide, peracetyl borate, an adduct of H₂O₂ and polyvinyl pyrrolidone, sodium percarbonate, potassium percarbonate, mixtures thereof, or the like. Preferred hydrogen peroxide adducts include percarbonate salt, urea peroxide, peracetyl borate, an adduct of H₂O₂ and polyvinyl pyrrolidone, or mixtures thereof. Preferred hydrogen peroxide adducts include sodium percarbonate, potassium percarbonate, or mixtures thereof, preferably sodium percarbonate.

Active Oxygen Compound Adducts

Active oxygen compound adducts include any generally known, and that preferably can function as a source of active oxygen and as part of the stabilized composition. Hydrogen peroxide adducts, or peroxyhydrates, are preferred. Some examples of active oxygen compound adducts include the following:

alkali metal percarbonates, for example sodium percarbonate (sodium carbonate peroxyhydrate), potassium percarbonate, rubidium percarbonate, cesium percarbonate, and the like; ammonium carbonate peroxyhydrate, and the like; urea peroxyhydrate, peroxyacetyl borate; an adduct of H₂O₂ polyvinyl pyrrolidone, and the like, and mixtures of any of the above.

Alkali metal percarbonates are preferred, with sodium percarbonate being the most preferred. However, it should be noted that in some embodiments, as illustrated in the examples, the active oxygen compound does not include sodium percarbonate.

Organic Active Oxygen Compounds

Any of a variety of organic active oxygen compounds can be employed in the compositions and methods of the present invention. For example, the organic active oxygen compound can be a peroxycarboxylic acid, such as a mono- or di- peroxycarboxylic acid or an ester peroxycarboxylic acid, an alkali metal salt including these types of compounds, or an adduct of such a compound. Preferred peroxycarboxylic acids include C₁-C₂₄ peroxycarboxylic acid, salt of C₁-C₂₄ peroxycarboxylic acid, ester of C₁-C₂₄ peroxycarboxylic acid, diperoxycarboxylic acid, salt of diperoxycarboxylic acid, ester of diperoxycarboxylic acid, or mixtures thereof.

Preferred peroxycarboxylic acids include C₁-C₁₀ aliphatic peroxycarboxylic acid, salt of C₁-C₁₀ aliphatic peroxycarboxylic acid, ester of C₁-C₁₀ aliphatic peroxycarboxylic acid, or mixtures thereof; preferably salt of or adduct of peroxyacetic acid; preferably peroxyacetyl borate. Preferred diperoxycarboxylic acids include C₄-C₁₀ aliphatic diperoxycarboxylic acid, salt of C₄-C₁₀ aliphatic diperoxycarboxylic acid, or ester of C₄-C₁₀ aliphatic diperoxycarboxylic acid, or mixtures thereof; preferably a sodium salt of perglutaric acid, of persuccinic acid, of peradipic acid, or mixtures thereof.

Organic active oxygen compounds include other acids including an organic moiety. Preferred organic active oxygen compounds include perphosphonic acids, perphosphonic acid salts, perphosphonic acid esters, or mixtures or combinations thereof.

Ester Peroxycarboxylic Acids

As used herein, ester peroxycarboxylic acid refers to a molecule having the formula:

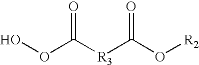

In this formula, R₂ and R₃ can independently be any of a wide variety of organic groups (e.g. alkyl, linear or cyclic, aromatic or saturated) or substituted organic groups (e.g., with one or more heteroatoms or organic groups). Ester peroxycarboxylic acid can be made using methods typically employed for producing peroxycarboxylic acid, such as incubating the corresponding monoester (described later) or diester (previously described) dicarboxylate with hydrogen peroxide. Ester peroxycarboxylic acids derived from or corresponding to the mono- or diester dicarboxylates described herein are preferred.

Preferred ester peroxycarboxylic acids include alkyl ester peroxycarboxylic acids, preferably having the formula:

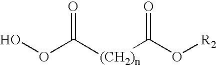

where R₂ represents an alkyl group having from 1 to 8 carbons and n is 0 to 6, preferably 1 to 5. The alkyl group can be either straight chain or branched. Preferably, R₂ is a methyl, ethyl, propyl (n-, iso-), butyl (n-, iso-, tert-), n-amyl, n-hexyl, or 2-ethylhexyl group. Preferably, n is 2, 3, 4, or 5. In one preferred embodiment, the composition of or employed in the present invention includes a mixture of alkyl ester peroxycarboxylic acids in which n is 2, 3, and 4. Such a mixture includes monoesters of peroxyadipic, peroxyglutaric, and peroxysuccinic acids. In another preferred embodiment, a majority of the ester peroxycarboxylic acid in the composition has x equal to 3. In a preferred embodiment, R₂ is a C₁-C₈ alkyl. In a preferred embodiment, n is 1, 2, 3, or 4. Most preferably, R₂ is a C₁ alkyl, C₂ alkyl, C₃ alkyl, or C₄ alkyl, and n is 2, 3 or 4, or a combination thereof. In another most preferred embodiment, R₂ is a C₅-C₈ alkyl, n is 5 or 6.

Alkyl ester peroxycarboxylic acids useful in this invention include monomethyl monoperoxyoxalic acid, monomethyl monoperoxymalonic acid, monomethyl monoperoxysuccinic acid, monomethyl monoperoxyglutaric acid, monomethyl monoperoxyadipic acid, monomethyl monoperoxysebacic acid; monoethyl monoperoxyoxalic acid, monoethyl monoperoxymalonic acid, monoethyl monoperoxysuccinic acid, monoethyl monoperoxyglutaric acid, monoethyl monoperoxyadipic acid, monoethyl monoperoxysebacic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, monopropyl monoperoxysebacic acid, in which propyl can be n- or iso-propyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, monobutyl monoperoxysebacic acid, in which butyl can be n-, iso-, or t-butyl; monoamyl monoperoxyoxalic acid, monoamyl monoperoxymalonic acid, monoamyl monoperoxysuccinic acid, monoamyl monoperoxyglutaric acid, monoamyl monoperoxyadipic acid, monoamyl monoperoxysebacic acid, in which amyl is n-; monohexyl monoperoxysebacic acid, in which hexyl is n-; mono-2-ethylhexyl monoperoxysebacic acid.

Peroxycarboxylic Acids

Peroxycarboxylic (or percarboxylic) acids generally have the formula R(CO₃H)ₙ, where R is an alkyl, arylalkyl, cycloalkyl, aromatic, heterocyclic, or ester group, such as an alkyl ester group; and n is one, two, or three, and named by prefixing the parent acid with peroxy. Ester groups are defined as R groups including organic moieties (such as those listed above for R) and ester moieties. Preferred ester groups include aliphatic ester groups, such as R₁OC(O)R₂— where each of R₁ and R₂ can be aliphatic, preferably alkyl, groups described above for R. Preferably R₁ and R₂ are each independently small alkyl groups, such as alkyl groups with 1 to 8 carbon atoms.

While peroxycarboxylic acids are not as stable as carboxylic acids, their stability generally increases with increasing molecular weight. Thermal decomposition of these acids can generally proceed by free radical and nonradical paths, by photodecomposition or radical-induced decomposition, or by the action of metal ions or complexes. Percarboxylic acids can be made by the direct, acid catalyzed equilibrium action of hydrogen peroxide with the carboxylic acid, by autoxidation of aldehydes, or from acid chlorides, and hydrides, or carboxylic anhydrides with hydrogen or sodium peroxide.

Peroxycarboxylic acids useful in the compositions and methods of the present invention include peroxyformic, peroxyacetic, peroxypropionic, peroxybutanoic, peroxypentanoic, peroxyhexanoic, peroxyheptanoic, peroxyoctanoic, peroxynonanoic, peroxydecanoic, peroxyundecanoic, peroxydodecanoic, peroxylactic, peroxycitric, peroxymaleic, peroxyascorbic, peroxyhydroxyacetic (peroxyglycolic), peroxyoxalic, peroxymalonic, peroxysuccinic, peroxyglutaric, peroxyadipic, peroxypimelic and peroxysubric acid and mixtures thereof. Useful peroxycarboxylic acids also include the ester peroxycarboxylic acids described hereinabove.

Peroxy forms of carboxylic acids with more than one carboxylate moiety can have one or more of the carboxyl moieties present as peroxycarboxyl moieties. These peroxycarboxylic acids and their alkali metal salts have been found to provide good antimicrobial action with good stability in aqueous mixtures. In a preferred embodiment, the composition of or employed in the invention utilizes a combination of several different peroxycarboxylic acids.

In preferred embodiment, the composition includes one or more alkyl ester peroxycarboxylic acids and, optionally, a peroxycarboxylic acid having from 2 to 12 carbon atoms. Preferably, such a composition includes peroxyacetic acid, or peroxyoctanoic acid, or peroxydecanoic acid, and monomethyl monoperoxyoxalic acid, monomethyl monoperoxymalonic acid, monomethyl monoperoxysuccinic acid, monomethyl monoperoxyglutaric acid, monomethyl monoperoxyadipic acid; monoethyl monoperoxyoxalic acid, monoethyl monoperoxymalonic acid, monoethyl monoperoxysuccinic acid, monoethyl monoperoxyglutaric acid, monoethyl monoperoxyadipic acid; monopropyl monoperoxyoxalic acid, monopropyl monoperoxymalonic acid, monopropyl monoperoxysuccinic acid, monopropyl monoperoxyglutaric acid, monopropyl monoperoxyadipic acid, in which propyl can be n- or isopropyl; monobutyl monoperoxyoxalic acid, monobutyl monoperoxymalonic acid, monobutyl monoperoxysuccinic acid, monobutyl monoperoxyglutaric acid, monobutyl monoperoxyadipic acid, in which butyl can be n-, iso-, or tert-butyl; monoamyl oxalic acid, monoamyl malonic acid, monoamyl succinic acid, monoamyl glutaric acid, monoamyl adipic acid, monoamyl sebacic acid, in which amyl is n-; monohexyl sebacic acid, in which hexyl is n-; and mono-2-ethylhexyl sebacic acid, or mixtures thereof.

Compositions Including Active Oxygen Compound

In certain embodiments, the stabilized composition includes about 30 to about 80 wt- % active oxygen compound; about 40 to about 70 wt- % active oxygen compound; about 5 to about 60 wt- % active oxygen compound; about 25 to about 60 wt- % active oxygen compound; about 50 to about 60 wt- % active oxygen compound; or about 55 wt- % active oxygen compound.

In certain embodiments, the stabilized composition includes as a lower limit about 5, about 10, about 20, about 25, about 30, about 40, about 50, about 60, about 70, or about 80 wt- % active oxygen compound up to an upper limit of about 20, about 30, about 40, about 50, about 60, about 70, about 80, or about 90 wt- % active oxygen compound, or each of these end points not modified by about. In certain embodiments, the stabilized composition includes about 30, about 40, about 50, about 55, about 60, about 65, about 70, about 75, about 80, about 85, or about 90 wt- % active oxygen compound, or any of these amounts not modified by about.

Builder

Builders can be included in the stabilized compositions of the present invention for purposes including assisting in controlling mineral hardness and stabilizing the active oxygen compound. Builders include chelating agents (chelators), sequestering agents (sequestrants), detergent builders, and the like. Inorganic as well as organic builders can be used. The builder can also function as a threshold agent when included in an effective amount. The builder preferably functions to stabilize the active oxygen compound in liquid compositions, such as liquid use or concentrate compositions. Preferably, the level of chelating agent builder is sufficient to prevent precipitation in hard water. The level of builder can vary widely depending on the end use of the composition and its desired physical form.

Builders generally useful in the present compositions include phosphonic acid and phosphonates, phosphates, aminocarboxylates, polycarboxylates, inorganic builders, organic builders, salts thereof, combinations or mixtures thereof, and the like.

Preferred builder mixtures include a mixture of aminocarboxylate builder (e.g., EDTA) and monomeric polycarboxylate builder (e.g., citric acid or citrate builder). Preferably, the aminocarboxylate builder and the polycarboxylate builder are selected to be and are employed at a concentration that is effective to stabilize an active oxygen compound, such as a peroxide, in a liquid composition. Preferably, the mixture of builders is effective to stabilize active oxygen compound to the extent that at least about 50% of the active oxygen compound remains in a liquid composition after 24 hours at 120° F. Preferably, at least about 70% of the active oxygen compound remains in a liquid composition after 24 hours at 120° F. Preferably, the liquid composition includes about 0.01 to about 20 wt- % of the solid (e.g., powder) stabilized composition.

Preferred stabilized compositions include as builder condensed phosphate, phosphonate, aminocarboxylate, polycarboxylate, alkali metal carbonate, or mixtures thereof. Preferred condensed phosphates include sodium tripolyphosphate. Preferred compositions include as builder aminocarboxylate (e.g., EDTA) and polycarboxylate (e.g., citric acid or alkali metal citrate salt). Such compositions can also include alkali metal carbonate, which can function, for example, as additional builder and/or alkalinity source. Preferred polycarboxylates include citric acid or citrate salt (e.g., alkali metal salt).

Preferred stabilized compositions include as builder water soluble compounds that do not contain phosphorus. Suitable water soluble compounds that do not contain phosphorus include aminocarboxylates and polycarboxylates. Preferred aminocarboxylates include nitrilotriacetic acid, EDTA, their alkali metal salts, and mixtures thereof. Preferred polycarboxylates include citrate builders. Preferably, the composition includes as builder nitrilotriacetate, citric acid, ethylene diamine tetraacetate, salt thereof, or mixture thereof.

For a further discussion of builders, see Kirk-Othmer, Encyclopedia of Chemical Technology, Third Edition, volume 5, pages 339-366 and volume 23, pages 319-320, the disclosure of which is incorporated by reference herein.

Phosphonates

Phosphonates suitable for use as a builder in the present compositions and methods include those that are suitable for stabilizing the active oxygen compound in combination with another builder. Such phosphonates include inorganic phosphonic acid, organic phosphonates, and amino phosphonates. Suitable phosphonates include phosphonic acids and salts, such as alkali metal salts, thereof.

Preferred sequestrants include phosphonic acids and phosphonate salts, such as 1-hydroxy ethylidene-1,1-diphosphonic acid (CH₃C(PO₃H₂)₂OH) (HEDP), amino[tri(methylene phosphonic acid)] (ATMP), ethylene diamine[tetra methylene-phosphonic acid)], 2-phosphene butane-1,2,4-tricarboxylic acid (PBTC), hexamethylenediamine penta(methylene phosphonic acid), as well as their alkyl metal salts, ammonium salts, or alkyloyl amine salts, such as mono, di, or tetra-ethanolamine salts. A preferred organic combination is ATMP and DTPMP. Preferably, the stabilized composition includes as builder phosphonate and the phosphonate includes amino tri(methylene phosphonic) acid; 1-hydroxyethylidene-1,1-diphosphonic acid; diethylenetriaminopenta(methylene phosphonic) acid; salts thereof, or mixtures thereof.

Suitable phosphonates include phosphorus acid, H₃PO₃, and its salts.

Additional suitable phosphonates include organic phosphonates. Organic phosphonates include low molecular weight phosphonopolycarboxylic acids, such as one having about 2-4 carboxylic acid moieties and about 1-3 phosphonic acid groups. Some examples of organic phosphonates include 1-hydroxyethane-1,1-diphosphonic acid: CH₃C(OH)[PO(OH)₂]₂; 1-phosphono-1-methylsuccinic acid, phosphonosuccinic acid; 2-phosphonobutane-1,2,4-tricarboxylic acid; other similar organic phosphonates; salts thereof; and mixtures thereof.

Suitable phosphonates include amino phosphonates, phosphonates with an amino or imino (e.g. nitrogen) moiety. Such amino phosphonates include: ethylene diamine (tetramethylene phosphonates); nitrilotrismethylene phosphates; diethylenetriamine (pentamethylene phosphonates); aminotri(methylenephosphonic acid): N[CH₂PO(OH)₂]₃; aminotri(methylenephosphonate), sodium salt:

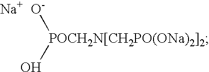

2-hydroxyethyliminobis(methylenephosphonic acid) HOCH₂CH₂N[CH₂PO(OH)₂]₂; diethylenetriaminepenta(methylenephosphonic acid) (HO)₂POCH₂N[CH₂CH₂N[CH₂PO(OH)₂]₂]₂; diethylenetriaminepenta(methylenephosphonate), sodium salt C₉H₍₂₈₋ₓ₎N₃NaₓO₁₅P₅ (x=7); hexamethylenediamine(tetramethylenephosphonate), potassium salt C₁₀H₍₂₈₋ₓ₎N₂KₓO₁₂P₄ (x=6); bis(hexamethylene)triamine(pentamethylenephosphonic acid) (HO₂)POCH₂N[(CH₂)₆N[CH₂PO(OH)₂]₂]₂. These amino phosphonates commonly contain alkyl or alkaline groups with less than 8 carbon atoms.

Commercially available phosphonates include those sold under the trade name DEQUEST® including, for example, 1-hydroxyethylidene-1,1-diphosphonic acid, available from Monsanto Industrial Chemicals Co., St. Louis, Mo., as DEQUEST® 2010; amino(tri(methylenephosphonic acid)), (N[CH₂PO₃H₂]₃), available from Monsanto as DEQUEST® 2000; ethylenediamine[tetra(methylenephosphonic acid)] available from Monsanto as DEQUEST® 2041; and 2-phosphonobutane-1,2,4-tricarboxylic acid available from Mobay Chemical Corporation, Inorganic Chemicals Division, Pittsburgh, Pa, as Bayhibit AM; and amino[tri(methylene phosphonic acid)] (ATMP) available as Briquest 301-50A: Amino Tri (Methylene Phosphonic Acid) (ATMP), 50%, low ammonia from Albright & Wilson.

Phosphonic acids can be used in the form of water soluble acid salts, particularly the alkali metal salts, such as sodium or potassium; the ammonium salts; or the alkylol amine salts where the alkylol has 2 to 3 carbon atoms, such as mono-, di-, or triethanolamine salts. If desired, mixtures of the individual phosphonic acids or their acid salts can also be used. A neutralized or alkaline phosphonate, or a combination of the phosphonate with an alkali source prior to being added into the mixture such that there is little or no heat or gas generated by a neutralization reaction when the phosphonate is added is preferred.

Phosphates

Phosphates for use as a builder in the present compositions and methods include any that are suitable for stabilizing the active oxygen compound in combination with another builder. Suitable phosphates can provide soil dispersion, detergency, water hardness control, and the like to the present composition. Phosphate-containing detergent builders include phosphates such as phosphoric acid and its salts, condensed or polyphosphates and their salts, and aminophosphates and their salts. Suitable condensed or polyphosphates include tripolyphosphates, pyrophosphates, and glassy polymeric meta-phosphates; and their salts, such as alkali metal, ammonium, alkanolammonium, and mixed salts. Examples of such suitable phosphates include sodium or potassium orthophosphate, sodium or potassium pyrophosphate, sodium or potassium tripolyphosphate, sodium hexametaphosphate, and the like. Suitable aminophosphates include nitrilotrismethylene phosphates and other aminophosphates with alkyl or alkaline groups with less than 8 carbon atoms. Such phosphates can assist, to a limited extent, in solidification of the composition by fixing the free water present in the composition as water of hydration.

Preferably, the stabilized composition includes as builder condensed phosphate and the condensed phosphate includes sodium tripolyphosphate, potassium tripolyphosphate, magnesium tripolyphosphate, sodium pyrophosphate, potassium pyrophosphate, sodium hexametaphosphate, potassium hexametaphosphate, or a mixture thereof. Preferred condensed phosphates include sodium tripolyphosphate.

Aminocarboxylates

Aminocarboxylates for use as a builder in the present compositions and methods include any that are suitable for stabilizing the active oxygen compound in combination with another builder. Aminocarboxylate builders or sequestrants include acid and/or salt forms (e.g., alkali metal salts) of these compounds. Examples of aminocarboxylates include amino acetates and salts thereof. Suitable amino acetates include: N-hydroxyethylaminodiacetic acid; hydroxyethylenediaminetetraacetic acid; nitrilotriacetic acid (NTA); ethylenediaminetetraacetic acid (EDTA); N-hydroxyethyl-ethylenediaminetriacetic acid (HEDTA); diethylenetriaminepentaacetic acid (DTPA); and alanine-N,N-diacetic acid; n-hydroxyethyliminodiacetic acid; and the like; their alkali metal salts; and mixtures thereof.

Polycarboxylates

Polycarboxylates for use as a builder in the present compositions and methods include any that are suitable for stabilizing the active oxygen compound in combination with another builder. As used herein, polycarboxylate refers either or both of the acid and salt forms. Preferred polycarboxylates include iminodisuccinic acids (IDS), sodium polyacrylates, citric acid, gluconic acid, oxalic acid, salts thereof, mixtures thereof, and the like. Additional preferred polycarboxylates include citric or citrate-type chelating agent, polymeric polycarboxylate, acrylic or polyacrylic acid-type stabilizing agents. Preferred polycarboxylates include citric acid or citrate salt (e.g., alkali metal salt).

Examples of low molecular weight polycarboxylates suitable as builders include: C₄-C₂₀-di-, -tri- and -tetracarboxylic acids, such as succinic acid, propanetricarboxylic acid, butanetetracarboxylic acid, cyclopentanetetracarboxylic acid and alkyl- and alkenylsuccinic acids with C₂-C,₆-alkyl- or -alkenyl radicals; C₄-C₂₀-hydroxy carboxylic acids, such as malic acid, tartaric acid, gluconic acid, glutaric acid, citric acid, lactobionic acid and sucrosemono-, -di- and -tricarboxylic acids; aminopolycarboxylates, such as nitrilotriacetic acid, methylglycinediacetic acid, alaninediacetic acid, ethylenediaminetetraacetic acid and serinediacetic acid.

Examples of oligomeric or polymeric polycarboxylates suitable as builders include: oligomaleic acids as described, for example, in EP-A-451 508 and EP-A-396 303; co- and terpolymers of unsaturated C₄-C₈-dicarboxylic acids, possible co-monomers which may be present being monoethylenically unsaturated monomers from group (i) in amounts of up to 95% by weight, from group (ii) in amounts of up to 60% by weight, from group (iii) in amounts of up to 20% by weight. Examples of suitable unsaturated C₄-C₈-dicarboxylic acids include maleic acid, fumaric acid, itaconic acid and citraconic acid.

The group (i) includes monoethylenically unsaturated C₃-C₈-monocarboxylic acids, such as acrylic acid, methacrylic acid, crotonic acid and vinylacetic acid, for example acrylic acid and methacrylic acid. Group (ii) includes monoethylenically unsaturated C₂-C₂₂-olefins, vinyl alkyl ethers with C₁-C₈-alkyl groups, styrene, vinyl esters of C₁-C₈-carboxylic acids, (meth)acrylamide and vinylpyrrolidone, for example C₂-C₆-olefins, vinyl alkyl ethers with C₁-C₄-alkyl groups, vinyl acetate and vinyl propionate. Group (iii) includes (meth)acrylic esters of C₁-C₈-alcohols, (meth)acrylnitrile, (meth)acrylamides of C₁-C₈-amines, N-vinylformamide and vinylimidazole.

If the polymers contain vinyl esters as monomers of group (ii) these can also be partially or completely hydrolyzed to vinyl alcohol structural units. Suitable co- and terpolymers are disclosed, for example, in U.S. Pat. No. 3,887,806 and DE-A 43 13 909.

Suitable copolymers of dicarboxylic acids include copolymers of maleic acid and acrylic acid in the ratio of 10:90 to 95:5 by weight. These can have a ratio of from 30:70 to 90:10 by weight, with molecular weights of from 10,000 to 150,000. Terpolymers of maleic acid, acrylic acid and a vinyl ester of a C₁-C₃-carboxylic acid can be employed with the ratio of from 10 (maleic acid):90 (acrylic acid+vinyl ester) to 95 (maleic acid):5 (acrylic acid+vinyl ester) by weight, for example, with the ratio of acrylic acid to vinyl ester in the range from 20:80 to 80:20 by weight. By way of further example, terpolymers of maleic acid, acrylic acid and vinyl acetate or vinyl propionate can have the ratio of from 20 (maleic acid):80 (acrylic acid+vinyl ester) to 90 (maleic acid):10 (acrylic acid+vinyl ester) by weight, for example, with the ratio of acrylic acid to the vinyl ester in the range from 30:70 to 70:30 by weight. Additional copolymers of maleic acid with C₂-C₈-olefins have the molar ratio from 40:60 to 80:20 for, for example, copolymers of maleic acid with ethylene, propylene or isobutene in the molar ratio 50:50.

Graft polymers of unsaturated carboxylic acids on low molecular weight carbohydrates or hydrogenated carbohydrates can be employed as polycarboxylate builders. Such graft polymers are described in, for example, U.S. Pat. No. 5,227,446, DE-A-44 15 623, DE-A-43 13 909. Suitable unsaturated carboxylic acids for graft polymers include, for example, maleic acid, fumaric acid, itaconic acid, citraconic acid, acrylic acid, methacrylic acid, crotonic acid and vinylacetic acid, and mixtures of acrylic acid and maleic acid, which are grafted on in amounts of from 40 to 95% of the weight of the component to be grafted. It is additionally possible for up to 30% by weight, based on the component to be grafted, of other monoethylenically unsaturated monomers to be present for modification. Suitable modifying monomers include the abovementioned monomers of groups (ii) and (iii).

Suitable grafting bases include degraded polysaccharides, such as acidically or enzymatically degraded starches, inulins or cellulose, reduced (hydrogenated or reductively aminated) degraded polysaccharides, such as mannitol, sorbitol, aminosorbitol and glucamine, and polyalkylene glycols with molecular weights of up to 5,000 such as polyethylene glycols, ethylene oxide/propylene oxide or ethylene oxide/butylene oxide block copolymers, random ethylene oxide/propylene oxide or ethylene oxide/butylene oxide copolymers, alkoxylated mono- or polyhydric C₁-C₂₂-alcohols, see U.S. Pat. No. 4,746,456.

Suitable graft polymers include grafted degraded or degraded reduced starches and grafted polyethylene oxides, employing from 20 to 80% by weight of monomers, based on the grafting component, in the graft polymerization. These can include a mixture of maleic acid and acrylic acid in the ratio of from 90:10 to 10:90 by weight for grafting.

Polyglyoxylic acids suitable as builders are described, for example, in EP-B-001 004, U.S. Pat. No. 5,399,286, DE-A-41 06 355 and EP-A-656 914. The end groups of the polyglyoxylic acids may have various structures.

Polyamidocarboxylic acids and modified polyamidocarboxylic acids suitable as builders are disclosed, for example, in EP-A-454 126, EP-B-511 037, WO 94/01486 and EP-A-581 452.

Additional suitable builders include polyaspartic acid or cocondensates of aspartic acid with other amino acids, C₄-C₂₅-mono- or -dicarboxylic acids and/or C₄-C₂₅-mono- or -diamines. Polyaspartic acids prepared in phosphorus-containing acids and modified with C₆-C₂₂-mono- or -dicarboxylic acids or with C₆-C₂₂-mono- or -diamines are particularly preferably employed.

Condensation products of citric acid with hydroxy carboxylic acids or polyhydroxy compounds which are suitable as organic cobuilders are disclosed, for example, in WO 93/22362 and WO 92/16493. Carboxyl-containing condensates of this type normally have molecular weights of up to 10,000, preferably up to 5,000.

Polymeric polycarboxylates that can be employed in certain embodiments of the present invention include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

Inorganic Builders

Inorganic builders for use in the present compositions and methods include any that are suitable for stabilizing the active oxygen compound in combination with another builder. Suitable inorganic builders include silicates, carbonates, sulfates, salts or acid forms thereof, mixtures thereof, and the like. Preferred silicates include zeolites. Preferred carbonates include alkali metal salts, such as alkali metal carbonates, bicarbonates, and/or sesquicarbonates. Preferably the compositions and methods of the present invention include a builder including an alkali metal carbonate.

Organic Builders

Organic builders for use in the present compositions and methods include any that are suitable for stabilizing the active oxygen compound in combination with another builder. Organic builders include include those that are not aminocarboxylate builders or polycarboxylate builders. Suitable organic builders include 1,10-phenanthroline, salicylic acid, 5-sulfosalicylic acid, thioglycolic acid, 4,5-dihydroxy-benzene-1,3-disulfonic acid, and the like. Other suitable organic builders are described in Langes Handbook of Chemistry (13^{th} Edition, McGraw Hill, 1985), for example, at Table 5-15. Preferred organic builders include salicylic acid and substituted salicylic acids.

Compositions Including Builder

In certain embodiments, the stabilized composition includes about 5 to about 60 wt- % builder combination; about 10 to about 50 wt- % builder combination; about 10 to about 40 wt- % builder combination; about 15 to about 40 wt- % builder combination; about 20 to about 25 wt- % builder combination; or about 22 wt- % builder combination.

In certain embodiments, the builder combination in such a composition includes about 5 to about 95 wt- % of a first builder; about 40 to about 90 wt- % of a first builder; about 40 to about 70 wt- % of a first builder; or about 60 wt- % of a first builder. In certain embodiments, the builder combination in such a composition includes about 5 to about 95 wt- % of a second builder; about 10 to about 40 wt- % of a second builder; about 30 to about 60 wt- % of a second builder; or about 40 wt- % of a second builder.

In certain embodiments, the stabilized composition includes as a lower limit about 5, about 40, or about 60 wt- % of a first builder to an upper limit of about 60, about 70, about 90, or about 95 wt- % of first builder, or each of these endpoints not modified by about. In certain embodiments, the stabilized composition includes as a lower limit about 5, about 10, about 30, or about 40 wt- % of a second builder to an upper limit of about 40, about 60, or about 95 wt- % of second builder, or each of these endpoints not modified by about.

In certain embodiments, the stabilized composition includes as a lower limit about 5, about 10, about 15, about 20, about 30, about 40, about 50, about 60, or about 70, wt- % builder combination up to an upper limit of about 20, about 25, about 30, about 40, about 50, about 60, about 70, or about 80, or about 90 wt- % builder combination, or each of these endpoints not modified by about. In certain embodiments, the stabilized composition includes about 10, about 15, about 20, about 25, about 30, about 35, about 40, about 45, about 50, about 65, or about 70 wt- % builder combination, or any of these amounts not modified by about.

In certain embodiments, the builder combination in such a composition includes about 5 to about 95 wt- % polycarboxylic acid (e.g., citric acid); about 40 to about 90 wt- % polycarboxylic acid (e.g., citric acid); about 40 to about 70 wt- % polycarboxylic acid (e.g., citric acid); or about 60 wt- % polycarboxylic acid (e.g., citric acid). In certain embodiments, the builder combination in such a composition includes about 5 to about 95 wt- % aminocarboxylate (e.g., EDTA); about 10 to about 40 wt- % aminocarboxylate (e.g., EDTA); about 30 to about 60 wt- % aminocarboxylate (e.g., EDTA); or about 40 wt- % aminocarboxylate (e.g., EDTA).

In certain embodiments, the stabilized composition includes as a lower limit about 5, about 40, or about 60 wt- % polycarboxylic acid (e.g., citric acid) to an upper limit of about 60, about 70, about 90, or about 95 wt- % polycarboxylic acid (e.g., citric acid), or each of these endpoints not modified by about. In certain embodiments, the stabilized composition includes as a lower limit about 5, about 10, about 30, or about 40 wt- % aminocarboxylate (e.g., EDTA) to an upper limit of about 40, about 60, or about 95 wt- % aminocarboxylate (e.g., EDTA), or each of these endpoints not modified by about.

Additives

Stabilized compositions of or employed in the present invention can further include additional functional materials or additives that provide a beneficial property, for example, to harden the composition in solid form or to aid in dissolution when dispersed or dissolved in an aqueous solution, e.g., for a particular use. Examples of conventional additives include one or more of each of surfactant, water, salt or additional salt, alkalinity source, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, tablet dissolution aid, other such additives or functional ingredients, and the like, and mixtures thereof. Adjuvants and other additive ingredients will vary according to the type of composition being manufactured, and the intended end use of the composition.

Preferably, the composition includes as an additive one or more of alkalinity source, acidity source, cleaning enzyme, hardening agent, solubility modifier, detergent filler, defoamer, antimicrobial agent, a precipitation threshold agent or system, aesthetic enhancing agent, effervescent agent, activator for the active oxygen compound, or combinations thereof. Preferably, the composition includes as an additive one or more of source of alkalinity, cleaning enzyme, antimicrobial, activators for the active oxygen compound, or mixtures thereof.

Preferably, the stabilized composition includes nonionic surfactant, phosphonate, condensed phosphate, hydrogen peroxide adduct, C1-C6 carboxylic acid, alkali metal hydrogen carbonate, alkali metal hydrogen phosphate, alkali metal hydrogen sulfate, or combinations thereof. Preferably, the stabilized composition includes nonionic surfactant, aminocarboxylate, hydrogen peroxide adduct, C1-C6 carboxylic acid, alkali metal hydrogen carbonate, alkali metal hydrogen phosphate, alkali metal hydrogen sulfate, or combinations thereof.

Surfactant

The composition can include at least one cleaning agent which is preferably a surfactant or surfactant system. A variety of surfactants, or mixtures of surfactants, can be employed. Suitable surfactants include anionic, nonionic, and zwitterionic surfactants, which are commercially available from a number of sources. Preferred surfactants include nonionic surfactants. For a discussion of surfactants, see Kirk-Othmer, Encyclopedia of Chemical Technology, Third Edition, volume 8, pages 900-912.

Anionic surfactants useful in the present stabilized compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Preferred anionics are sodium alkylarylsulfonate, alpha-olefin sulfonate, and fatty alcohol sulfates. Examples of preferred anionic surfactants include sodium dodecylbenzene sulfonic acid, potassium laureth-7 sulfate, and sodium tetradecenyl sulfonate.

Nonionic surfactants are useful in the present stabilized compositions, include those having a polyalkylene oxide polymer as a portion of the surfactant molecule. Such nonionic surfactants include, for example, chlorine-, benzyl-, methyl-, ethyl-, propyl-, butyl- and other like alkyl-capped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine condensates, monoalkanolamine condensates, polyoxyethylene fatty acid amides, and the like; and ethoxylated amines and ether amines commercially available from Tomah Corporation and other like nonionic compounds. Silicone surfactants such as the ABIL B8852 (Goldschmidt) can also be used.

Additional suitable nonionic surfactants having a polyalkylene oxide polymer portion include nonionic surfactants of C6-C24 alcohol ethoxylates (preferably C6-C14 alcohol ethoxylates) having 1 to about 20 ethylene oxide groups (preferably about 9 to about 20 ethylene oxide groups); C6-C24 alkylphenol ethoxylates (preferably C8-C10 alkylphenol ethoxylates) having 1 to about 100 ethylene oxide groups (preferably about 12 to about 20 ethylene oxide groups); C6-C24 alkylpolyglycosides (preferably C6-C20 alkylpolyglycosides) having 1 to about 20 glycoside groups (preferably about 9 to about 20 glycoside groups); C6-C24 fatty acid ester ethoxylates, propoxylates or glycerides; and C4-C24 mono or dialkanolamides.

Specific alcohol alkoxylates include alcohol ethoxylate propoxylates, alcohol propoxylates, alcohol propoxylate ethoxylate propoxylates, alcohol ethoxylate butoxylates, and the like; nonylphenol ethoxylate, polyoxyethylene glycol ethers and the like; and polyalkylene oxide block copolymers including an ethylene oxide/propylene oxide block copolymer such as those commercially available under the trademark PLURONIC (BASF-Wyandotte), and the like.

Preferred nonionic surfactants include low foaming nonionic surfactants. Although, higher foaming nonionic surfactants can be employed in the compositions and methods of the present invention. Examples of preferred, low foaming, nonionic surfactants include secondary ethoxylates, such as those sold under the trade name TERGITOL™, such as TERGITOL™ 15-S-7 (Union Carbide), Tergitol 15-S-3, Tergitol 15-S-9 and the like. Other preferred classes of low foaming nonionic surfactant include alkyl or benzyl-capped polyoxyalkylene derivatives and polyoxyethylene/polyoxypropylene copolymers.

A useful nonionic surfactant for use as a defoamer is nonylphenol having an average of 12 moles of ethylene oxide condensed thereon, it being end capped with a hydrophobic portion comprising an average of 30 moles of propylene oxide. Silicon-containing defoamers are also well-known and can be employed in the compositions and methods of the present invention.

Preferred amphoteric surfactants include amine oxide compounds having the formula:

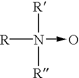

where R, R′, R″, and R′″ are each a C₁-C₂₄ alkyl, aryl or aralkyl group that can optionally contain one or more P, O, S or N heteroatoms.

Another class of preferred amphoteric surfactants includes betaine compounds having the formula:

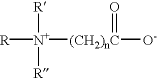

where R, R′, R″ and R′″ are each a C₁-C₂₄ alkyl, aryl or aralkyl group that can optionally contain one or more P, O, S or N heteroatoms, and n is about 1 to about 10.

Preferred surfactants include food grade surfactants, linear alkylbenzene sulfonic acids and their salts, and ethylene oxide/propylene oxide derivatives sold under the Pluronic™ trade name. A preferred surfactant is compatible as an indirect or direct food additive or substance; especially those described in the Code of Federal Regulations (CFR), Title 21—Food and Drugs, parts 170 to 186 (which is incorporated herein by reference).

Usually, stabilized compositions according to the present invention will contain no more than about 25 wt- % surfactant, preferably about 0.1-20 wt- %, preferably about 1.5-15 wt- %, preferably 0.1 to about 10 wt- % surfactant, and most preferably 0.1 to about 5 wt- % surfactant. Use dilutions of these concentrates preferably contain no more than about 10 wt- % surfactant, more preferably 0.1 to about 5 wt- % surfactant, and most preferably 0.1 to about 2 wt- %.

Compositions Including Surfactant

In certain embodiments, the stabilized composition includes about 1 to about 30 wt- % surfactant; about 1 to about 15 wt- % surfactant; about 1 to about 5 wt- % surfactant; about 1 to about 4 wt- % surfactant; about 1 to about 3 wt- % surfactant; about 4 to about 15 wt- % surfactant; about 6 to about 10 wt- % surfactant; about 7 to about 11 wt- % surfactant; or about 8 to about 10 wt- % surfactant. In certain embodiments, the stabilized composition includes about 1 to about 11 wt- % surfactant; about 1 to about 5 wt- % surfactant; about 1 to about 3 wt- % surfactant; about 5 to about 11 wt- % surfactant; about 6 to about 10 wt- % surfactant; about 7 to about 11 wt- % surfactant; about 8 to about 10 wt- % surfactant; or about 8 wt- % surfactant. In certain embodiments, the stabilized composition includes about 1 to about 15 wt- % surfactant; about 5 to about 15 wt- % surfactant; about 5 to about 10 wt- % surfactant; or about 7 wt- % surfactant.

In certain embodiments, the stabilized composition includes as a lower limit about 1, about 2, about 3, about 4, about 5, about 6, about 7, about 8, about 10, about 15, about 20, or about 25 wt- % surfactant up to an upper limit of about 2, about 3, about 4, about 5, about 6, about 7, about 8, about 10, about 11, about 15, about 20, or about 25 wt- % surfactant, or each of these endpoints not modified by about. In certain embodiments, the stabilized composition includes about 1, about 2, about 3, about 4, about 5, about 6, about 7, about 8, about 9, or about 10, about 11, about 15, about 20, about 25, or about 30 wt- % surfactant, or any of these amounts not modified by about.

Water

The stabilized compositions of or employed in the methods of the present invention can include water. Preferably, solid forms of the stabilized compositions include only 0 to about 10 wt- % water. It is believed that such low concentrations of water can help maintain stability of the active oxygen component of the composition in its solid form. In a liquid form particularly in the presence of water, the builder combination stabilizes the active oxygen compound. Preferably, a solid form of the stabilized composition contains only any water that forms part of the ingredients of the composition, that is, the composition is free of any added water. Preferably, a solid form of the stabilized composition is substantially free of water, that is, the composition includes less than about 1 wt- % water.

Salts

Some embodiments of the stabilized composition optionally include salt, or one or more additional salts, for example, alkali metal salt. The alkali metal salt can act as an alkalinity source to enhance cleaning of a substrate, and improve soil removal performance of the composition.

Additionally, in some embodiments the alkali metal salts can provide for the formation of an additional binder complex or binding agent including: alkali metal salt; organic sequestrant including a phosphonate, an aminocarboxylic acid, or mixtures thereof; and water. We refer to such binder complexes as “E-Form” hydrates. Such E-Form hydrates are discussed in detail in the following U.S. Patents and Patent Applications: U.S. Pat. Nos. 6,177,392 B1; 6,150,324; and 6,156,715; and 6,258,765; each of which is incorporated herein by reference. The binding agent can include the organic sequestrant and the active oxygen compound. Preferably the binding agent has melting transition temperature in the range of about 120° C. to 160° C.

Some examples of alkali metal salts include alkali metal carbonates, silicates, phosphates, phosphonates, sulfates, borates, or the like, and mixtures thereof. Alkali metal carbonates are more preferred, and some examples of preferred carbonate salts include alkali metal carbonates such as sodium or potassium carbonate, bicarbonate, sesquicarbonate, mixtures thereof, and the like; preferably sodium carbonate, potassium carbonate, or mixtures thereof.

In an embodiment, the active oxygen compound and the salt include a single preformed ingredient prior to addition to the mixture. Preferably, in such an embodiment, the active oxygen compound and the salt together include a hydrogen peroxide adduct. However, in a preferred version of such an embodiment, at least a portion of the salt is a separate ingredient from the active oxygen compound prior to addition to the mixture.

The composition can include in the range of 0 to about 80 wt- %, preferably about 15 to about 70 wt- % of an alkali metal salt, most preferably about 20 to about 60 wt- %.

Additionally, in some embodiments, salts, for example acidic salts, can be included as pH modifiers, sources of acidity, effervescing aids, or other like uses. Some examples of salts for use in such applications include sodium bisulfate, sodium acetate, sodium bicarbonate, citric acid salts, and the like and mixtures thereof. The composition can include in the range of 0.1 to 50% by weight such material. It should be understood that agents other than salts that act as pH modifiers, sources of acidity, effervescing aids, or like, can also be used in conjunction with the invention.

Alkalinity Sources

The stabilized composition of or employed in the present invention can include effective amounts of one or more inorganic detergents or alkaline sources to enhance cleaning of a substrate and improve soil removal performance of the composition. As discussed above, in embodiments including an alkali metal salt, such as alkali metal carbonate, the alkali metal salt can act as an alkalinity source. It should also be understood that in some embodiments, the active oxygen compound also can act as a source of alkalinity. The composition can include a secondary alkaline source separate from the active oxygen compound, and that secondary source can include about 0 to 75 wt- %, preferably about 0.1 to 70 wt- % of, in some embodiments, more preferably 1 to 25 wt- %, but in other embodiments, more preferably about 20 to 60 wt- % or 30 to 70 wt- % of the total composition.

Additional alkalinity sources can include, for example, inorganic alkalinity sources, such as an alkali metal hydroxide or silicate, or the like. Suitable alkali metal hydroxides include, for example, sodium or potassium hydroxide. An alkali metal hydroxide can be added to the composition in a variety of forms, including for example in the form of solid beads, powder, or other solid form, dissolved in an aqueous solution, or a combination thereof. Alkali metal hydroxides are commercially available as a solid in the form of prilled solids or beads having a mix of particle sizes ranging from about 12-100 U.S. mesh, or as an aqueous solution, as for example, as a 50 wt- % and a 73 wt- % solution.

Examples of usefuil alkaline metal silicates include sodium or potassium silicate (with a M₂O:SiO₂ ratio of 1:2.4 to 5:1, M representing an alkali metal) or metasilicate.

Other sources of alkalinity include a metal borate such as sodium or potassium borate, and the like; ethanolamines and amines; and other like alkaline sources. Any of a variety of known sources of alkalinity can also be used in conjunction with the invention.

Antimicrobial Agent

The compositions of or employed in the invention can contain an added antimicrobial agent. This added antimicrobial agent can be dispersed or dissolved in the stabilized composition or in the diluting solvent. Suitable additional antimicrobial agents include sulfonic acids (e.g., dodecylbenzene sulfonic acid); iodo-compounds or active halogen compounds (e.g., iodine, interhalides, polyhalides, metal hypochlorites, hypochlorous acid and its alkali metal salts, hypobromous acid and its alkali metal salts, chloro- and bromo-hydantoins, sodium chlorite, sodium trichloroisocyanurate, sodium dichloro isocyanate (anhydrous or dihydrate), iodine-poly(vinylpyrolidinone) complexes, and 2-bromo-2-nitropropane-1,3-diol); additional active oxygen compounds (e.g., organic peroxides including benzoyl peroxide, alkyl benzoyl peroxides, ozone, singlet oxygen generators); phenolic derivatives (e.g., o-phenyl phenol, o-benzyl-p-chlorophenol, tert-amyl phenol, C₁-C₆ alkyl hydroxy benzoates, pentachlorophenol, orthophenylphenol, and p-chloro-m-xylenol); phenyl or benzyl benzoate; or other antimicrobial agents such as metal derivatives, amines, alkanol amines, nitro derivatives, analides, organosulfur and sulfur-nitrogen compounds (e.g., hexahydro-1,3,5-tris(2-hydroxyethyl)-s-triazine, dithiocarbamates such as sodium dimethyldithiocarbamate); or a mixture of such antimicrobial agents. Typically, an added antimicrobial agent is employed in an amount sufficient to provide the desired degree of antimicrobial activity.

Phenyl or benzyl benzoate can also be included in the compositions of or employed in the present invention as an agent against micro-insects, for example, dust mites.

Compositions of or employed in the invention containing such optional additional antimicrobial agents typically have substantially greater antimicrobial effectiveness than comparison aqueous solutions or dispersions containing the additional antimicrobial agent alone. If present in the stabilized compositions of or employed in the invention, the additional antimicrobial agent preferably is 0.01 to about 30 wt- % of the composition, preferably 0.05 to about 10 wt- % and most preferably about 0.1 to about 5 wt- %. In a use solution the additional antimicrobial agent preferably is 0.001 to about 5 wt- % of the composition, preferably 0.01 to about 2 wt- %, and preferably 0.05 to about 0.5 wt- %. In some embodiments, an antimicrobial component, such as TAED can be included in the range of 0.001 to 75 wt- % of the composition, preferably 0.01 to 20 wt- %, and more preferably 0.05 to 10 wt- % of the composition.

In use, the antimicrobial agents are typically formed into a functional material that when diluted and dispensed, optionally, for example, using an aqueous stream forms an aqueous disinfectant or sanitizer composition that can be contacted with a variety of surfaces resulting in prevention of growth or the killing of a portion of the microbial population. A three log reduction of the microbial population results in a sanitizer composition. The antimicrobial agent can be encapsulated, for example, to improve its stability.

Activators

In some embodiments, the antimicrobial activity or bleaching activity of the composition can be enhanced by the addition of a material which, when the composition is placed in use, reacts with the active oxygen to form an activated component. For example, in some embodiments, a peracid or a peracid salt is formed. For example, in some embodiments, tetraacetylethylene diamine can be included within the composition to react with the active oxygen and form a peracid or a peracid salt that acts as an antimicrobial agent or can provide enhanced bleaching of stains. Other examples of active oxygen activators include transition metals and their compounds, compounds that contain a carboxylic, nitrile, or ester moiety, or other such compounds known in the art. Preferred activators include tetracetylethylenediamine, molybdenum-containing compound, polycarboxlic acid or its salts or esters (e.g. didecanoic acid), sulfonated or sulfated carboxylic acid or its salts or esters (e.g. the nonyl ester of the sulfonic acid of phenol), or mixtures thereof. In an embodiment, the activator includes tetraacetylethylene diamine; transition metal; compound that includes carboxylic, nitrile, amine, or ester moiety; or mixtures thereof.

In some embodiments, an activator component can include in the range of 0.001 to 75% by wt. of the composition, preferably 0.01 to 20, and more preferably 0.05 to 10% by wt of the composition.

In an embodiment, the activator for the active oxygen compound combines with the active oxygen to form an antimicrobial agent.

In an embodiment, the composition includes a solid block, and an activator material for the active oxygen is coupled to the solid block. The activator can be coupled to the solid block by any of a variety of methods for coupling one solid stabilized composition to another. For example, the activator can be in the form of a solid that is bound, affixed, glued or otherwise adhered to the solid block. Alternatively, the solid activator can be formed around and encasing the block. By way of further example, the solid activator can be coupled to the solid block by the container or package for the stabilized composition, such as by a plastic or shrink wrap or film.

Bleaching Agents

Bleaching agents for use in inventive formulations for lightening or whitening a substrate, include bleaching compounds capable of liberating an active halogen species, such as Cl₂, Br₂, I₂, ClO₂, BrO₂, IO₂, —OCl⁻, —OBr⁻ and/or, —OI⁻, under conditions typically encountered during the cleaning process. Suitable bleaching agents for use in the present stabilized compositions include, for example, chlorine-containing compounds such as a chlorite, a hypochlorite, chloramine. Preferred halogen-releasing compounds include the alkali metal dichloroisocyanurates, chlorinated trisodium phosphate, the alkali metal hypochlorites, alkali metal chlorites, monochloramine and dichloramine, and the like, and mixtures thereof. Encapsulated chlorine sources can also be used to enhance the stability of the chlorine source in the composition (see, for example, U.S. Pat. Nos. 4,618,914 and 4,830,773, the disclosure of which is incorporated by reference herein). A bleaching agent can also be an additional peroxygen or active oxygen source such as hydrogen peroxide, perborates, for example sodium perborate mono and tetrahydrate, sodium carbonate peroxyhydrate, phosphate peroxyhydrates, and potassium permonosulfate, with and without activators such as tetraacetylethylene diamine, and the like, as discussed above. A stabilized composition can include a minor but effective additional amount of a bleaching agent above that already available from the stabilized active oxygen compound, preferably about 0.1-10 wt- %, preferably about 1-6 wt- %.

Hardening Agents/Solubility Modifiers.

The present compositions can include a minor but effective amount of a secondary hardening agent, as for example, an amide such stearic monoethanolamide or lauric diethanolamide, or an alkylamide, and the like; a polyvinylalcohol or polyvinylester and the like; a polyvinylacrylate and the like; microcrystalline cellulose and the like; a solid polyethylene glycol, or a solid EO/PO block copolymer, and the like; starches that have been made water-soluble through an acid or alkaline treatment process; various inorganics that impart solidifying properties to a heated composition upon cooling, and the like. Such compounds can also vary the solubility of the composition in an aqueous medium during use such that the cleaning agent and/or other active ingredients can be dispensed from the solid composition over an extended period of time. The composition can include a secondary hardening agent in an amount of about 5-20 wt- %, preferably about 10-15 wt- %.

Detergent Fillers

A stabilized composition can include an effective amount of one or more detergent fillers, which does not perform as a cleaning agent per se, but cooperates with the cleaning agent to enhance the overall processing of the composition. Examples of fillers suitable for use in the present stabilized compositions include sodium sulfate, sodium chloride, starch, sugars, C₁-C₁₀ alkylene glycols such as propylene glycol, and the like. Preferably, a detergent filler is included in an amount of about 1-20 wt- %, preferably about 3-15 wt- %.

Defoaming Agents

An effective amount of a defoaming agent for reducing the stability of foam can also be included in the present stabilized compositions. Preferably, the stabilized composition includes about 0.0001-5 wt- % of a defoaming agent, preferably about 0.01-3 wt- %.

Examples of defoaming agents suitable for use in the present compositions include silicone compounds such as silica dispersed in polydimethylsiloxane, EO/PO block copolymers, alcohol alkoxylates, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like. A discussion of defoaming agents can be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated by reference herein. Preferred defoamers include polysiloxanes.

Optical Brighteners

Optical brightener is also referred to as fluorescent whitening agents or fluorescent brightening agents provide optical compensation for the yellow cast in fabric substrates. With optical brighteners yellowing is replaced by light emitted from optical brighteners present in the area commensurate in scope with yellow color. The violet to blue light supplied by the optical brighteners combines with other light reflected from the location to provide a substantially complete or enhanced bright white appearance. This additional light is produced by the brightener through fluorescence. Optical brighteners absorb light in the ultraviolet range 275 through 400 nm. and emit light in the ultraviolet blue spectrum 400-500 nm.

Fluorescent compounds belonging to the optical brightener family are typically aromatic or aromatic heterocyclic materials often containing condensed ring system. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.). The choice of optical brighteners for use in detergent compositions will depend upon a number of factors, such as the type of detergent, the nature of other components present in the detergent composition, the temperature of the wash water, the degree of agitation, and the ratio of the material washed to the tub size. The brightener selection is also dependent upon the type of material to be cleaned, e.g., cottons, synthetics, etc. Since most laundry detergent products are used to clean a variety of fabrics, the detergent compositions should contain a mixture of brighteners which are effective with a variety of fabrics. It is of course necessary that the individual components of such a brightener mixture be compatible.

Optical brighteners useful in the present invention are commercially available. Commercial optical brighteners which can be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents”, M. Zahradnik, Published by John Wiley & Sons, New York (1982), the disclosure of which is incorporated herein by reference.

Stilbene derivatives which can be useful in the present invention include, but are not necessarily limited to, derivatives of bis(triazinyl)amino-stilbene; bisacylamino derivatives of stilbene; triazole derivatives of stilbene; oxadiazole derivatives of stilbene; oxazole derivatives of stilbene; and styryl derivatives of stilbene.

Dyes/Odorants

Various dyes, odorants including perfumes, and other aesthetic enhancing agents can also be included in the composition. Dyes can be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), and the like.

Fragrances or perfumes that can be included in the compositions include, for example, terpenoids such as citronellol, aldehydes such as amyl cinnamaldehyde, a jasmine such as C1S-jasmine or jasmal, vanillin, and the like.

Aqueous Medium

The ingredients can optionally be processed in a minor but effective amount of an aqueous medium such as water to achieve a mixture, to aid in the solidification, to provide an effective level of viscosity for processing the mixture, and to provide the processed composition with the desired amount of firmness and cohesion during discharge and upon hardening. In a preferred embodiment, the water serves as a processing medium and also forms part of the binding agent, as described hereinabove. The mixture during processing typically includes about 0.2-10 wt- % of an aqueous medium, preferably about 0.5-9 wt- %.

Processing, Packaging, and Dispensing of the Composition

The composition can be processed to a solid form by a variety of known methods. For example, solid blocks can be made by the process discussed in detail in the following U.S. Patents and Patent Applications: U.S. Pat. Nos. 6,177,392 B1; 6,150,324; and 6,156,715; and U.S. patent application Ser. No. 08/989,824; each of which is incorporated herein by reference. A powdered composition can be prepared by simple mixing of the composition's components. An agglomerate can also be prepared by a variety of well-known methods. Liquid or gel compositions can be prepared by dissolving or suspending the ingredients of the composition in the liquid or gel medium, typically, with mixing.

The composition can be packaged in a variety of type of packages or packaging materials, such as, for example, a simple bottle or jar, a unit dose tablet or block, a “tear and pour” pouch, or a water-soluble packet.

The composition can be dispensed by any of a variety of known methods, such as, for example, eroding a solid block into water or dissolving a powder or agglomerate into water.

Liquid Use Compositions

Liquid use compositions can be formed by mixing a solid form of the stabilized composition with a liquid carrier, or by diluting a liquid concentrate form of the stabilized composition. Preferably, the liquid is water and the liquid use composition is an aqueous preparation. Liquid use compositions can include about 0.01 to about 20 wt- % of the solid form of the stabilized composition, preferably about 0.1 to about 10 wt- %, preferably about 0.1 to about 5 wt- %, most preferably about 0.5% to about 3 wt- %. Therefore, the liquid use compositions of or employed in the present invention can include the ranges or amounts of ingredients employed in the solid or concentrate stabilized compositions multiplied, for example, by 0.1%, by 0.5%, by 3%, by 5%, by 10%, by 20%, or by any value within the ranges recited for liquid use compositions.

Preferred liquid use compositions (e.g., aqueous preparations) include about 0.1 to about 10 wt- % of the stabilized composition, and have a pH of about 7 to about 11. Preferably, the pH is about 9 to about 10, preferably, less than 10. Preferred liquid use compositions (e.g., aqueous preparations) include about 0.2 to about 9 wt- % active oxygen compound; about 0.005 to about 1.1 wt- % surfactant; and about 0.1 to about 6 wt- % builder; and have a pH of about 7 to about 11. Preferably, this pH is about 9 to about 10, preferably less than 10. Preferred liquid use compositions (e.g., aqueous preparations) include about 0.4 to about 0.9 wt- % active oxygen compound; about 0.01 to about 0.11 wt- % surfactant; and about 0.2 to about 0.6 wt- % builder. These preferred liquid use compositions can have a pH of about 9 to about 10, preferably less than 10.

The liquid use composition can include, for example, about 0.5 to about 0.8 wt- % sodium percarbonate; about 0.01 to about 0.2 wt- % alcohol ethoxylate, alkylbenzene sulfonate, or mixtures thereof; and about 0.2 to about 0.4 wt- % non-phosphate builder, preferably in an aqueous preparation. In certain embodiments, such an aqueous preparation has a pH of about 7 to about 11, of about 9 to about 10, or less than 10.

The liquid use composition includes a mixture of builders effective to stabilize active oxygen compound in the liquid use composition. That is, the mixture of builders forms a liquid use composition in which the active oxygen compound remains at a higher concentration for a longer time than in a liquid use composition lacking that combination and/or quantity of builders. Preferably, a liquid use composition according to the present invention includes active oxygen compound stabilized to the extent that at least about 50% of the active oxygen compound remains in a liquid composition after 24 hours at 120° F. Preferably, at least about 70% of the active oxygen compound remains in the liquid composition after 24 hours at 120° F. Preferably, such a stabilized liquid composition includes about 0.01 to about 20 wt- % of the solid (e.g., powder) stabilized composition.

The present invention can be better understood with reference to the following example. This example is intended to be representative of specific embodiments of the invention, and is not intended as limiting the scope of the invention.

### EXAMPLE

Stabilization of Active Oxygen Compounds by Compositions of the Present Invention

A stabilized composition according to the present invention was formulated and tested for stabilization of active oxygen compounds.

Materials and Methods

A powdered cleaning and sanitizing composition was prepared by blending together the components shown below.

| | Fixed | Variable |
|---|---|---|
| Ingredient | Wt-% | Wt-% |
| Builder, Tetrasodium EDTA | 9 | 0-22 |
| Builder, Citric Acid | 13 | 0-22 |
| Nonionic surfactant; | 7 | 7 |
| Sodium Carbonate | 18 | 18 |
| Active Oxygen Compound, | 53 | 53 |
| Sodium Percarbonate | | |

This powder composition was dissolved in water at 1 wt- % and active oxygen compound was subsequently determined as peroxide. Peroxide was determined by titration with potassium permanganate according to well known procedures.

Results

Liquid compositions of the “fixed” formula were made at a concentration of 1 wt- % in deionized water and tap water and stored at room temperature. The level of peroxide was measured and remained steady for up to 8 days after the liquid composition was made.

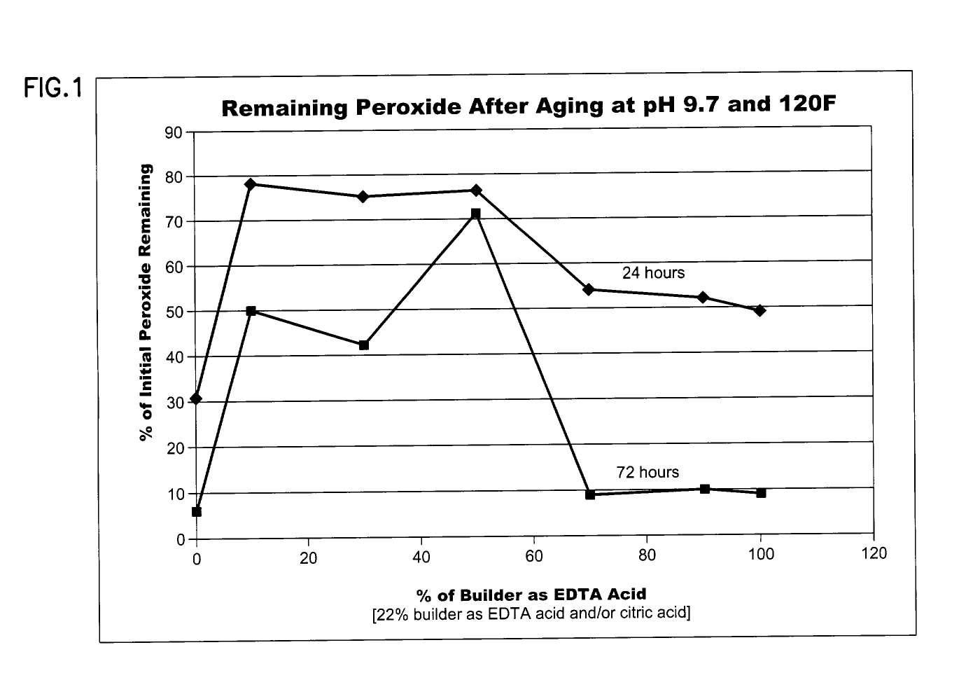

Liquid compositions of the “variable” formula were made at a concentration of 1 wt- % and heated to 120° F. for up to 72 hours. The results of this test are shown in FIG. 1. In this test, the active oxygen compound (measured as peroxide) was stable for 24 hours at 120° F. with builder including 5 to 95 wt- % aminocarboxylate and 5 to 95 wt- % polycarboxylic acid. The active oxygen compound exhibited greater stability for 24 hours at 120° F. with builder including 10 to 90 wt- % aminocarboxylate and 10 to 90 wt- % polycarboxylic acid, and even greater stability with builder including 10 to 60 wt- % aminocarboxylate and 40 to 90 wt- % polycarboxylic acid. The active oxygen compound (measured as peroxide) was stable for 72 hours at 120° F. with builder including 10 to 60 wt- % aminocarboxylate and 40 to 90 wt- % polycarboxylic acid.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

All publications and patent applications in this specification are indicative of the level of ordinary skill in the art to which this invention pertains.

The invention has been described with reference to various specific and preferred embodiments and techniques. However, it should be understood that many variations and modifications may be made while remaining within the spirit and scope of the invention.

We claim:

1. A composition comprising:
about 30 to about 90 wt- % active oxygen compound; and
about 20 to about 60 wt- % builder combination;
wherein the builder combination is effective to stabilize the active oxygen compound when the composition is formulated as an alkaline liquid.

2. The composition of claim 1, comprising:
about 30 to about 80 wt- % active oxygen compound; and
about 5 to about 60 wt- % builder combination.

3. The composition of claim 1, comprising:
about 40 to about 70 wt- % active oxygen compound; and
about 10 to about 40 wt- % builder combination.

4. The composition of claim 1, comprising:
about 50 to about 60 wt- % active oxygen compound; and
about 20 to about 25 wt- % builder combination.

5. The composition of claim 1, comprising:
about 55 wt- % active oxygen compound; and
about 53 wt- % builder combination.

6. The composition of claim 2, wherein the builder combination comprises about 5 to about 95 wt- % polycarboxylic acid and about 5 to about 95 wt- % aminocarboxylate.

7. The composition of claim 3, wherein the builder combination comprises about 40 to about 90 wt- % polycarboxylic acid and about 10 to about 40 wt- % aminocarboxylate.

8. The composition of claim 4, wherein the builder combination comprises about 40 to about 70 wt- % polycarboxylic acid and about 30 to about 60 wt- % aminocarboxylate.

9. The composition of claim 5, wherein the builder combination comprises about 60 wt- % polycarboxylic acid and about 40 wt- % aminocarboxylate.

10. The composition of claim 1, comprising:
about 5 to about 60 wt- % active oxygen compound; and
about 10 to about 50 wt- % builder combination.

11. The composition of claim 1, comprising:
about 25 to about 50 wt- % active oxygen compound; and
about 15 to about 40 wt- % builder combination.

12. The composition of claim 1, comprising:
about 50 to about 60 wt- % active oxygen compound; and
about 20 to about 25 wt- % builder combination.

13. The composition of claim 1, comprising:
about 55 wt- % active oxygen compound; and
about 53 wt- % builder combination.

14. The composition of claim 10, wherein the builder combination comprises about 5 to about 95 wt- % polycarboxylic acid and about 5 to about 95 wt- % aminocarboxylate.

15. The composition of claim 11, wherein the builder combination comprises about 40 to about 90 wt- % polycarboxylic acid and about 10 to about 40 wt- % aminocarboxylate.

16. The composition of claim 12, wherein the builder combination comprises about 40 to about 70 wt- % polycarboxylic acid and about 30 to about 60 wt- % aminocarboxylate.

17. The composition of claim 13, wherein the builder combination comprises about 60 wt- % polycarboxylic acid and about 40 wt- % aminocarboxylate.

18. The composition of claim 1, wherein the builder combination comprises aminocarboxylate and monomeric polycarboxylate.

19. The composition of claim 18, wherein the aminocarboxylate comprises EDTA.

20. The composition of claim 18, wherein the polycarboxylate comprises citric acid or a salt thereof.

21. The composition of claim 18, wherein the builder combination comprises about 5 to about 95 wt- % polycarboxylic acid and about 5 to about 95 wt- % aminocarboxylate.

22. The composition of claim 18, wherein the builder combination comprises about 40 to about 90 wt- % polycarboxylic acid and about 10 to about 40 wt- % aminocarboxylate.

23. The composition of claim 18, wherein the builder combination comprises about 40 to about 70 wt- % polycarboxylic acid and about 60 to about 60 wt- % aminocarboxylate.

24. The composition of claim 18, wherein the builder combination comprises about 60 wt- % polycarboxylic acid and about 40 wt- % aminocarboxylate.

25. A method of cleaning an object, comprising:
applying to the object an aqueous preparation of a stabilized composition of claim 1.

26. The method of claim 25, wherein the aqueous preparation has a pH of about 7 to about 11.

27. The method of claim 26, wherein the aqueous preparation has a pH of about 9 to about 10.

28. The method of claim 27, wherein the aqueous preparation has a pH less than 10.

29. A method of stabilizing an active oxygen compound comprising formulating the active oxygen compound in a liquid composition comprising a builder combination, wherein the builder combination is effective to stabilize the active oxygen compound when the composition is formulated as an alkaline liquid.
